(19) United States
(12) Patent Application Publication
(10) Pub. No.: US 2010/0077587 A1
(43) Pub. Date: Apr. 1, 2010

(54) Method of repairing a housing of an aircraft engine

(75) Inventors: Jan Oke PETERS, Hamburg (DE); Thomas Maria Gartner, Hamburg (DE)

Correspondence Address: MORRISON & FOERSTER LLP, 1650 TYSONS BOULEVARD, SUITE 400, MCLEAN, VA, 22102, US

(73) Assignee: Lufthansa Technik AG, Hamburg (DE)

(21) Appl. No.: 12/429,863

(22) Filed: Apr. 24, 2009

(30) Foreign Application Priority Data
Sep. 26, 2008 (DE) 10 2008 049 055.5

(51) Int. Cl. B23P 6/00

(52) U.S. Cl. 29/402.01

(57) ABSTRACT

A method of repairing a housing part of an aircraft engine. An existing cylindrical bore can be widened to a conical bore or a conical bore can be produced. A filler comprising a material of the same type as a material of the housing part can be prepared. The filler can have a conical peripheral surface configured to fit into the conical bore. The filler can be rotated so that material of the filler and material of the housing part heat up by rotational friction and are plastified. The filler and the housing part can be upset against each other in an axial direction. The filler can be worked so that it finishes flush with the housing part. If a cylindrical bore was initially present, a bore corresponding to the original bore can be produced through the filler.

### REFERENCE TO RELATED APPLICATIONS

This application claims the priority of German Patent Application No. 10 2008 049 055.5, filed Sep. 26, 2008, the contents of which are incorporated herein by reference.

### FIELD OF THE INVENTION

The invention relates to a method of repairing a housing of an aircraft engine.

### BACKGROUND OF THE INVENTION

In the case of aircraft engines, the housing is regularly made up of a number of housing parts, the connection between housing parts being established by means of housing flanges. Screws extend through bores in the flanges and hold the housing parts together. The invention relates on the one hand to the repair of the housing flanges in the region of such a bore. On the other hand, the invention relates generally to the repair of housing parts.

If a housing part of an aircraft engine is damaged, for example by corrosion or mechanical influences, it has previously not been possible in many cases for the housing part to be used any further, but instead it must be replaced by a new part. There is no known method by which damage in housing parts can be eliminated without at the same time weakening the material structure.

High-pressure compressor housings of aircraft engines are especially susceptible to corrosion in the bores of the housing flange. Rules of repair specify that the corroded bore should be reamed out until the material attacked by corrosion is removed. Reaming out of the bore is only admissible up to a prescribed maximum diameter. If the corrosion reaches deeper into the material, repair according to the rules of repair is not possible and the housing must be scrapped. A comparable repair problem arises if bores in the housing flange are worn out by mechanical stress.

As an alternative to the method according to the rules of repair, it has been attempted to widen the bore beyond the maximum admissible diameter and weld a filler into the bore by means of TIG welding or electron beam welding. The filler can subsequently be worked in such a way that the contour of the flange and the bore are restored. Welding operations in which the material is melted lead to reduced strength and under some circumstances to distortion of the material. In the case of housings of aircraft engines, this cannot be accepted. These methods therefore cannot be used in practice.

### SUMMARY OF THE INVENTION

Against the background of the prior art cited at the beginning, the invention is based on the object of presenting a method of repairing a housing part that can also be used when the damage to the material is not confined to the surface of the housing part or the surface of a bore formed in the housing part but reaches deep into the material.

In the case of a first embodiment of the method according to the invention, first a cylindrical bore existing in a housing flange is widened to a conical bore. A filler with a conical peripheral surface is prepared, the conical peripheral surface fitting into the conical bore. The material of the filler is of the same type as the material of the housing flange. The filler is set in rotation in such a way that material of the filler and of the housing flange heats up by rotational friction and is plastified. The filler and the housing flange are upset against each other in the axial direction, so that an intimate connection is produced. The housing flange with the inserted filler is worked in such a way that the filler finishes flush with the housing flange. Finally, a bore corresponding to the original cylindrical bore is produced through the filler.

First of all, a number of terms are explained. The conical peripheral surface of the filler fits into the conical bore when there is contact between the conical peripheral surface and the wall of the conical bore over the entire circumference in the inserted state. The contact may extend over the surface area or it may only exist along an edge. A necessary condition for the filler to fit the conical bore is that the smallest diameter of the filler is smaller than the largest diameter of the conical bore and that the largest diameter of the filler is larger than the smallest diameter of the conical bore.

Two materials are of the same type if they are based on the same base alloy. The sameness of type is not lost if, for example, the materials are subjected to different steps of heat treatment.

The steps according to the invention of rotating and upsetting may be separate from each other or combined with each other. So it is possible for the rotation to be stopped when the material is adequately plastified. Only subsequently is the force acting on the axial direction increased, so that the filler and the housing flange are upset against each other. In the case of an alternative embodiment of the method according to the invention, the force acting in the axial direction is increased at the end, without the rotation previously being stopped. Furthermore, the upsetting may also consist in that the force acting in the axial direction is continuously increased already during the rotation. Finally, it is possible for a great force to be present in the axial direction throughout the rotation and for the rotation to be stopped at the end, without increasing the force.

Methods in which a piece of material is plastified by friction in order to connect it to a second, likewise plastified piece of material are known by the term friction welding. In friction welding, the material to be connected is not heated beyond the melting point, but instead merely a plastified state of the material is brought about. Unlike in the case of classical welding, transformation of the material into the liquid phase is avoided, so there is also no transition from liquid to solid during cooling. Such phase transitions are what bring about a change in the material structure in classical welding.

The invention makes it possible to go so deeply into the material surrounding the bore that the corrosion or other damage is eliminated completely. The material removed is replaced by the filler, with the properties of the replacement material being very close to the properties of the original material. The housing flange and the bore in the housing flange are therefore restored, while the stability of a connection established by means of the housing flange is not reduced in comparison with the original part.

In the case of high-pressure compressor housings of aircraft engines, the material of the housing flange is often a martensitic steel. In a long series of trials, it has been possible to demonstrate that the method of friction welding can also be used in the case of martensitic steel and that, with suitable selection of the method parameters, the original material properties are virtually retained. This was not to be expected, because martensitic steel can only be welded with great difficulty by classical methods and considerable changes of the material properties regularly occur. In particular, the method according to the invention can be used in the case of an alloy known by the designation M152, with fractions of 12% Cr, 2.5% Ni, 1.8% Mo and 0.33% V. Furthermore, it has been possible to demonstrate that the size of the bore with a diameter of 8.5 mm and a length of 5 mm does not fundamentally preclude the use of friction welding. It is possible to carry out the friction welding in such a way that an intimate connection between the filler and the housing flange is produced over the entire circumference of the filler and over the entire thickness of the material of the housing flange of 5 mm. The method according to the invention can therefore be used in the case of a diameter of the bore of more than 4 mm and a material thickness of the housing flange of more than 2 mm.

A major aspect when carrying out the method is to use the rotational friction in such a way that both the filler and the conical bore are uniformly plastified over the entire surface area that is to be connected. A good force transmission for the rotational friction between the filler and the bore is achieved by both the filler and the bore having a conical form. Preferably, the wall of the conical bore is inclined with respect to the axial direction of the bore by an angle of inclination of between 15° and 30°. The angle of inclination of the filler may be identical to the angle of inclination of the conical bore, so that the peripheral surface of the filler can lie against the conical bore with surface-area contact. Then a very great torque is required to set the filler in rotation with respect to the conical bore. A lower driving force for the filler is adequate if the angle of inclination of the filler deviates slightly from the angle of inclination of the conical bore. The deviation is preferably between 0.5° and 8°, more preferably between 1° and 4°.

If the angle of inclination of the filler is larger than the angle of inclination of the conical bore, the rotational friction initially acts in the wide part of the conical bore. Only when the material in this region is plastified does the rotational friction continue in the direction of the narrower part of the conical bore. If the angle of inclination of the filler is smaller than the angle of inclination of the conical bore, the rotational friction initially acts in the narrow part of the conical bore and then continues into the wide part of the conical bore. In initial trials, the latter has lead to better results.

In the case of the method according to the invention, excessive dissipation of thermal energy to the surroundings in the superficial regions of the housing flange, and resultant impairment of the intimate connection between the filler and the housing flange, must be avoided. Excessive dissipation of thermal energy can be prevented by the housing flange being backed in the region of the conical bore with a plate before the rotational friction between the filler and the housing flange is produced. In order to avoid the filler not only becoming welded to the housing flange but also to the plate behind it, the plate may have an opening. The plate is arranged in such a way that the opening and the conical bore coincide.

If the coincidence is such that the opening in the plate is larger than the outlet of the conical bore, however, there is the risk of an inhomogeneous material flow at the outlet of the conical bore. The quality of the connection between the filler and the housing flange may suffer and cracks may occur in the material. In order to avoid this, the opening may be smaller than the outlet of the conical bore. In the region in which the material of the filler and the material of the housing flange are plastified by rotational friction, the plate then rests on the housing flange and prevents inhomogeneous material flow.

The opening in the plate will often have a cylindrical form. However, it has been found that a better connection between the filler and the housing flange is achieved if the opening in the plate tapers conically. In the case of a preferred embodiment, the angle of inclination of the conically tapering opening is equal to the angle of inclination of the wall of the conical bore, so that the opening extends the conical bore without a kink. The angle of inclination of the opening may also be smaller than or larger than the angle of inclination of the conical bore. The conical form of the opening in the plate is of significance particularly in the direct vicinity of the outlet of the conical bore, because there the plate has a direct influence on the properties of the plastified material. In the region away from the conical bore, the opening in the plate may also have a different form and, for example, go over into a cylindrical bore.

The material of the plate is preferably steel. A good result of the method is achieved if the plate consists of a steel with a good cubic face-centered lattice structure, which has a low thermal conductivity. Once the friction welding has been completed, the plate is removed again. If the plate has become connected to the flange during the friction welding, it must be removed by a metal-cutting method. In order to make this easier, the plate may be made up of a number of parts lying one on top of the other. A first, preferably thinner, part rests on the flange. If this part is connected to the flange, it can be removed by a metal-cutting method with little effort. A second part rests on the first part. The second part can be simply lifted off after the friction welding, since it has not become connected to the first part.

In order to ensure that a homogeneous connection between the filler and the housing flange forms over the entire height of the conical bore, a high-power friction welding machine is required. If the power is too low, the quality of the material connection suffers in the region of the inlet of the conical bore, that is to say where the conical bore has its largest diameter. In order to avoid this problem, a sacrificial plate may be provided, placed onto the housing flange from this side before the beginning of the friction welding. The sacrificial plate has an opening, which makes access to the inlet of the conical bore possible. The opening in the sacrificial plate is preferably conical, while more preferably the angle of inclination is equal to the angle of inclination of the conical bore. With a suitable selection of the method parameters, the sacrificial plate is also plastified in the transitional region to the conical bore and is thereby conducive to the uniform connection between the filler and the housing flange. In an advantageous embodiment, the sacrificial plate consists of a material which is of the same type as the material of the housing flange and of the filler. The material of the sacrificial plate can then mix with the plastified material of the filler and of the housing flange and contribute to a homogeneous connection.

Although the properties of the material change to a significantly lesser extent during friction welding and if the material is melted, stresses in the material as a consequence of the friction welding still occur. To reduce the stresses, the material may be annealed before the machining. The annealing time is preferably longer than in the case of normal annealing by at least a factor of two. A two-stage annealing operation, in which the material is treated for three hours at a temperature of 564° C. in the first step and is treated for three hours at a temperature of 511° C. in the second step, is typical for martensitic steel. In the case of the method according to the invention, the first step may be extended, for example to nine hours, while the second step remains unchanged.

In the case of the second embodiment of the method according to the invention, the housing part is not damaged in the region of a bore, but directly on its surface. In order to repair such damage, first a conical bore is produced in the housing part. The conical bore is arranged and dimensioned in such a way that the damaged parts of the material are removed completely and that the conical bore is bounded exclusively by undamaged material. A filler with a conical peripheral surface is prepared, the filler consisting of a material of the same type as the housing part and the conical peripheral surface fitting in the conical bore. The filler is set in rotation, so that material of the filler and of the housing part heats up by rotational friction and is plastified. The filler and the housing part are upset in the axial direction and the filler is worked in such a way that it finishes flush with the housing part. Finishing flush means here that no edges or offsets exist any longer at the transition between the housing part and the filler. In particular, the contour of the housing part can be restored in such a way that it corresponds to the original contour of the housing part before the occurrence of the damage.

All features and steps with which the first embodiment of the method according to the invention can be optionally supplemented can also be combined with the second embodiment of the method according to the invention.

### BRIEF DESCRIPTION OF THE DRAWINGS

The invention is described by way of example below on the basis of advantageous embodiments with reference to the appended drawings, in which:

FIG. 1 shows a cut-out representation of two housing parts in the joined-together state;

FIG. 2 shows a cutout of a housing part in the dismantled state;

FIGS. 3-4 show schematic representations of the method according to the invention;

FIG. 5 shows an alternative embodiment of the method according to the invention;

FIG. 6 shows a cutout from a housing part;

FIG. 7 shows the view from FIG. 6 after the production of a conical bore; and

FIG. 8 shows the view from FIG. 6 after completion of the repair method.

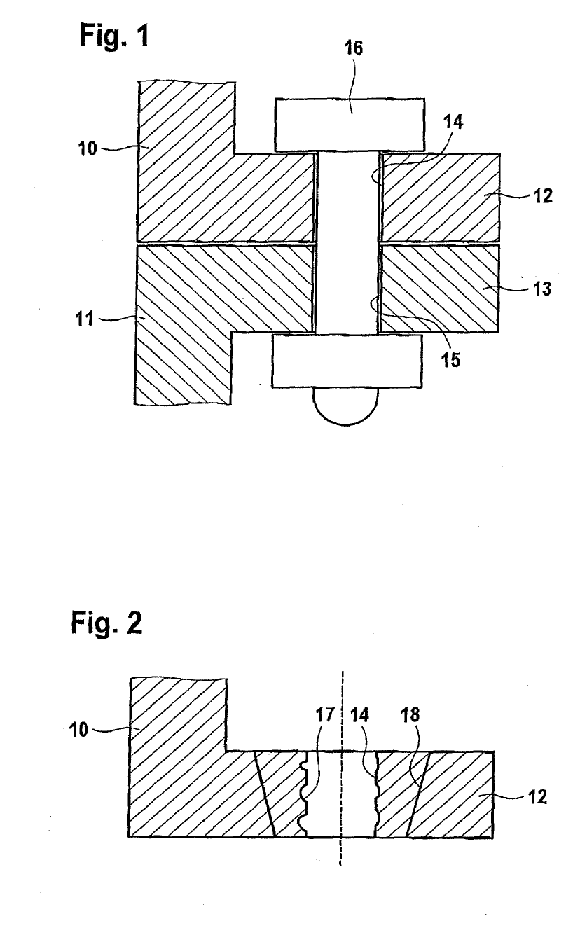

### DETAILED DESCRIPTION OF THE INVENTION

The housing of an aircraft engine is joined together from a plurality of housing parts 10, 11. Formed on the housing parts 10, 11 are flanges 12, 13, by means of which the housing parts 10, 11 lie against each other. The flanges 12, 13 are 5 mm thick. Cylindrical bores 14, 15 with a diameter of 8.5 mm are formed in the flanges 12, 13. The bores 14, 15 are in line with each other when the engine has been assembled, so that the housing parts 10, 11 can be connected to each other by means of a screw connection 16.

When the housing has been dismantled, as in FIG. 2, in many cases corrosion is found in the wall of the bore 14, as indicated by reference numeral 17. The method according to the invention serves for repairing such bores in the housing flange of aircraft engines damaged by corrosion or mechanical stress.

In the first step of the repair method, the bore 14 is widened to a conical bore 18, going so deeply into the housing flange 12 that the material attacked by corrosion is removed completely. The wall of the conical bore 18 is inclined with respect to the axial direction by an angle α.

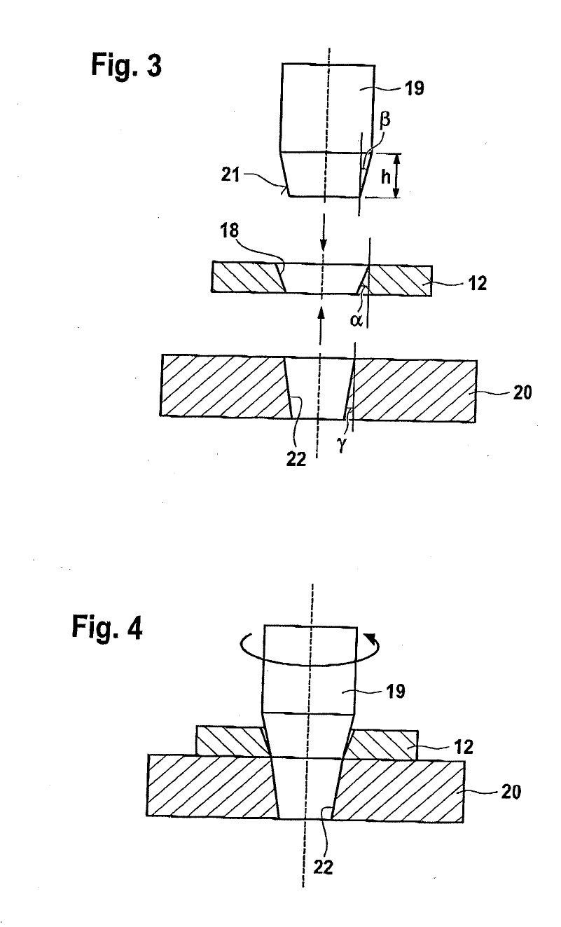

A filler 19, shown in FIG. 3, and a plate 20 are prepared. The filler 19 consists of the same material as the housing flange 12, namely the martensitic steel M152, with fractions of 12% Cr, 2.5% Ni, 1.8% Mo and 0.33% V. The material of the plates 20 is a cubic face-centerd steel with low thermal conductivity. Formed on the filler 19 is a conical peripheral surface 21, fitting the conical bore 18. The peripheral surface is inclined with respect to the axial direction by an angle β and extends over a height h, which is greater than the material thickness of the housing flange. The height h may be, for example, 8 mm. The plate 20 comprises a conical opening 22 with an angle of inclination γ with respect to the axial direction.

The plate 20 is placed onto the housing flange 12 in such a way that the opening 22 is arranged concentrically with the conical bore 18. In this exemplary embodiment, the diameter of the opening 22 is of exactly the same size as the outlet of the conical bore 18. In the case of other embodiments, the diameter of the opening 22 is smaller. The filler 19 is inserted into the conical bore 18, so that contact between the conical peripheral surface 21 and the conical bore 18 exists over the complete circumference of the filler 19. In the exemplary embodiments, the smallest diameter of the conical peripheral surface 21 coincides with the smallest diameter of the conical bore 18. The contact between the conical peripheral surface 21 and the conical bore 18 therefore occurs in this region.

If the filler 19 is then set in rotation, the material of the filler 19 and the material of the housing flange 12 heat up in this region and are finally plastified. Through the plastified material, the filler 19 can penetrate deeper into the conical bore 18, whereby further material is plastified. Once the filler 19 has penetrated into the conical bore so far that the material is plastified over the entire height of the conical bore 18, the rotation of the filler 19 is stopped. The filler is upset against the housing flange 12, so that an intimate connection forms between the material of the filler 19 and the material of the housing flange 12. The upsetting has the effect that impurities such as oxides are also forced out of the joining zone with the plastified material. This completes the friction welding operation.

After removing the plate 20 from the housing flange 12, the material is annealed in order to reduce stresses. Subsequently, the filler 19, which is then connected to the housing flange 12 in one piece, can be machined, so that it finishes flush with the surface of the housing flange 12. Finally, a new cylindrical bore is produced through the filler 19, the position and dimensions of said new bore corresponding to the original cylindrical bore 14. The repaired housing flange corresponds in its material properties and in its strength to the original housing flange

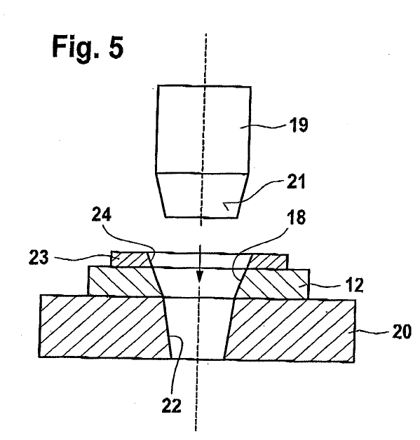

In the embodiment of FIG. 5, a sacrificial plate 23 has been additionally placed onto the housing flange 12 from above. The sacrificial plate 23 has an opening 24, which allows access to the inlet of the conical bore 18. The opening 24 in the sacrificial plate 23 tapers conically, the angle of inclination coinciding with the angle of inclination of the conical bore 18.

If the filler 19 is inserted into the conical bore 18 and set in rotation, not only material of the housing flange 12 but also part of the material of the sacrificial plate 23 is plastified. The plastified material of the housing flange 12, which is of the same type as the material of the sacrificial plate 23, flows into the joining zone; it is therefore sacrificed to be conducive to the homogeneous connection between the filler 19 and the housing flange 12. The remaining material of the sacrificial plate 22 is removed by machining. The sacrificial plate 23 makes it possible to achieve a homogeneous connection over the entire height of the conical bore 18 even with a friction welding machine of somewhat reduced power.

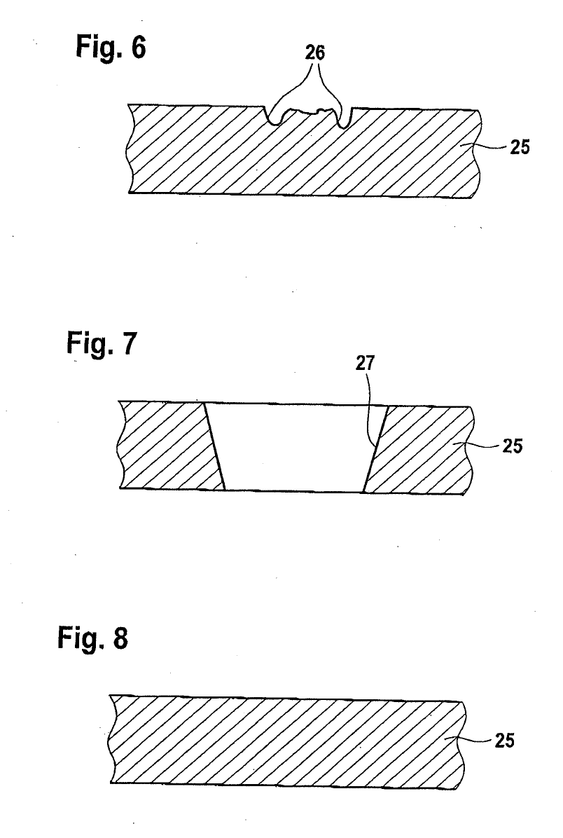

FIG. 6 shows a cutout of a housing part 25, the surface of which has damage 26 caused by corrosion. According to FIG. 7, a conical bore 27 is produced in the housing part 25, completely removing the damaged parts of the material. The conical bore 27 is completely surrounded by undamaged material. After carrying out the repair method according to the invention, as described in detail with reference to FIGS. 2 to 5, a uniform connection between the filler 19 and the housing part 25 is produced. The surface of the housing part 25 is then machined in such a way that the original contour is restored and the state shown in FIG. 8 is obtained.

1. A method of repairing a housing flange of an aircraft engine, comprising:
widening a cylindrical bore in the housing flange to a conical bore;
preparing a filler with a conical peripheral surface, the filler comprising a material of the same type as a material of the housing flange and the conical peripheral surface being configured to fit into the conical bore;
fitting the conical peripheral surface of the filler into the conical bore;
rotating the filler so that material of the filler and material of the housing flange heat up by rotational friction and are plastified;
upsetting the filler and the housing flange in an axial direction;
working the filler so that it finishes substantially flush with a surface of the housing flange; and
producing a new bore through the filler, the new bore corresponding to the cylindrical bore.

2. The method of claim 1, wherein the material of the housing flange and the material of the filler comprise martensitic steel.

3. The method of claim 2, wherein the martensitic steel comprises 12% Cr, 2.5% Ni, 1.8% Mo and 0.33% V.

4. The method of claim 1, wherein a wall of the conical bore is inclined with respect to the axial direction by an angle of inclination of between 15° and 30°.

5. The method of claim 1, wherein an angle of inclination of the conical peripheral surface deviates from an angle of inclination of the conical bore by 0.5° to 8°.

6. The method of claim 5, wherein the angle of inclination of the the conical peripheral surface is smaller than the angle of inclination of the conical bore.

7. The method of claim 1, wherein the housing flange is backed with a plate before rotating the filler.

8. The method of claim 7, wherein the plate comprises an opening and wherein the opening and an outlet of the conical bore coincide.

9. The method of claim 8, wherein a diameter of the opening is smaller than a diameter of the conical bore.

10. The method of claim 8, wherein the opening tapers conically.

11. The method of claim 7, wherein the plate comprises steel with a cubic face-centered lattice structure.

12. The method of claim 1, wherein a sacrificial plate is placed onto the housing flange before rotating the filler such that an inlet of the conical bore is accessible through an opening in the sacrificial plate.

13. The method of claim 12, wherein the opening in the sacrificial plate tapers conically.

14. The method of claim 13, wherein the sacrificial plate comprises a material of the same type as a material of the housing flange.

15. The method of claim 1, wherein the housing flange is annealed with the filler before working the filler.

16. A method of repairing a housing part of an aircraft engine, comprising:
producing a conical bore in the housing part;
preparing a filler with a conical peripheral surface, the filler comprising a material of the same type as a material of the housing part and the conical peripheral surface being configured to fit into the conical bore;
fitting the conical peripheral surface of the filler into the conical bore;
rotating the filler so that material of the filler and material of the housing part heat up by rotational friction and are plastified;
upsetting the filler and the housing part in an axial direction; and
working the filler so that it finishes substantially flush with a surface of the housing part.

17. The method of claim 1, wherein an angle of inclination of the conical peripheral surface deviates from an angle of inclination of the conical bore by 1° to 4°.
